(19) United States
(12) Patent Application Publication
(10) Pub. No.: US 2009/0194385 A1
(43) Pub. Date: Aug. 6, 2009

(54) Positive-Fit Freewheel Mechanism That Can Be Electromechanically Actuated, Electromechanical Brake With A Freewheel Mechanism Of This Type For A Motor Vehicle and Method For Adjusting The Play In A Brake Of This Type

(76) Inventors: Chi-Thuan Cao, Korntal-Muenchingen (DE); Dirk Hofmann, Stuttgart (DE); Herbert Vollert, Vaihingen/Enz (DE); Willi Nagel, Remseck/Hochdorf (DE); Bertram Foitzik, Ilsfeld (DE); Bernd Goetzelmann, Sindelfingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/304,610

(22) PCT Filed: May 23, 2007
(86) PCT No.: PCT/EP2007/054985

§ 371 Date: Dec. 12, 2008

(30) Foreign Application Priority Data
Jul. 7, 2006 (DE) 102006031508.1

(51) Int. Cl. F16D 41/08; F16D 67/06

(52) U.S. Cl. 192/12 B; 192/46

(57) ABSTRACT

The invention relates to an electromechanically switchable form-locking freewheel mechanism for preventing an electromechanical brake from releasing. According to the invention, the freewheel mechanism is embodied in the form of an electric motor in which a pivot angle of the armature is limited, the armature is counterbalanced and has a locking element that cooperates with a gear. The invention permits a compactly designed freewheel mechanism that can be integrated into an electromechanical actuating unit of the electromechanical brake. The counterbalancing of the armature equipped with the locking element prevents external accelerations of the freewheel mechanism of the kind that can occur during driving operation of a motor vehicle from exerting a moment on the armature that could switch off the freewheel mechanism. A method for adjusting the clearance of an electromechanical brake is also provided.

### PRIOR ART

The invention relates to an electromechanically switchable form-locking freewheel mechanism with the defining characteristics of claim 1. In particular, the freewheel mechanism is provided for use in an electromechanical brake for a motor vehicle in order to modify the brake into an auxiliary brake (parking brake). The invention also relates to an electromechanical brake of this kind for a motor vehicle, equipped with a freewheel mechanism as recited in the preamble to claim 8 and to a method for adjusting the clearance in the brake as recited in the preamble to claim 10.

Freewheel mechanisms are intrinsically known; they are also referred to as one-way clutches. A freewheel mechanism prevents a component, for example a shaft or a cage/housing, from rotating in a locking direction and permits the component to rotate in the opposite rotation direction, which is referred to as the freewheeling direction. The prevention of rotation in the locking direction can also occur in relation to a second rotatable component, e.g. the housing/cage can be prevented from rotating in relation to the shaft. A switchable freewheel mechanism can be switched off; when switched off, it is inoperative. When switched on, the freewheel mechanism has the above-explained locking action that prevents rotation in the locking direction.

DE 102 34 848 A1 has disclosed an electromechanical brake equipped with an electromechanically switchable, form-locking freewheel mechanism. The freewheel mechanism is capable of setting the brake in the actuated position; the generated braking force is maintained when the brake is without current. As a result, the known brake, which is initially a service brake, is modified into a service and auxiliary brake. Auxiliary brakes are also referred to as parking brakes.

The freewheel mechanism of the known brake is equipped with a bar that is situated radially in relation to a gear and is able to slide radially in relation to the gear. The bar functions as a locking element of the freewheel mechanism. The gear has a sawtooth-shaped gearing and the bar, at its end oriented toward the gear, has an oblique surface that is oriented toward the oblique flanks of the teeth of the gear. The known freewheel mechanism is equipped with an electromagnet for sliding the bar. In order to switch on the freewheel mechanism, the bar is brought into engagement with the teeth of the gear and, engaging with radial tooth flanks, prevents the gear from rotating in a locking direction. When the gear is rotated in the opposite direction, the oblique tooth flanks push against the oblique surface of the bar, causing it to disengage, thus permitting the gear to rotate in a freewheeling direction opposite from the locking direction when the freewheel mechanism is switched on. In order to switch off the freewheel mechanism, the bar is retracted, i.e. is disengaged from the teeth of the gear.

The known brake has an electromechanical actuating unit equipped with an electric motor and a planetary roller screw drive for actuation of the brake and is able to press a friction brake lining against a rotatable brake element to be braked. In the case of a disc brake, the brake element is a brake disc; in a drum brake, the brake element is a brake drum. The planetary roller screw drive constitutes a reduction gear and a rotation/translation converting gear that converts a rotating drive motion of the electric motor into a translatory movement in order to press the friction brake lining against the brake element.

### DISCLOSURE OF THE INVENTION

The freewheel mechanism according to the present invention with the defining characteristics of claim 1 has an armature that is embodied in a fashion comparable to a rotor of an electric motor, but its pivoting angle is limited. The armature is equipped with the locking element that can be brought into engagement with the teeth of a gear through a pivoting of the armature in one direction. In this switched-on position of the freewheel mechanism, by engaging with the teeth of the gear in a form-locking fashion, the locking element prevents the gear from rotating in the locking direction since the pivoting angle of the armature is limited. In the other rotation direction, i.e. the freewheeling direction, the teeth of the gear push the locking element out of engagement; the gear is able to rotate in the freewheeling direction. In order to switch off the freewheel mechanism, the armature is pivoted in the other direction so that the locking element disengages from the gear. The gear is able to rotate in both directions. Preferably, the freewheel mechanism is switched off passively through rotation of the gear in the freewheeling direction; this causes the teeth of the gear to push the locking element out of engagement and into the switched-off position. Then the electromagnet is without current.

The electromagnet of the freewheel mechanism according to the invention has a yoke that is embodied in the fashion of a stator of an electric motor and encompasses the armature. By supplying current to the electromagnet, a moment is exerted on the armature, which brings the locking element into or out of engagement with the gear, i.e. switches the freewheel mechanism on or off. The electric motor and the armature can be designed so that with the reversal of the current supply to the electromagnet. It is possible to switch the freewheel mechanism on and off with the electromagnet. It is possible to reverse the direction of the electromagnet's action, for example when the electromagnet cooperates with a permanent magnet. There are also possible designs in which the electromagnet switches the freewheel mechanism either on or off. The opposite switching motion is produced, for example, by means of a spring element.

In comparison to a frictionally engaging, so-called clamping freewheel mechanism, the form-locking embodiment of the freewheel mechanism according to the invention gives it the advantage that it does not inadvertently disengage from the switched-on, locked state. In a clamping freewheel mechanism, it is conceivable for an inadvertent release to occur due to sliding movements between the clamping element(s) that constitute(s) the locking elements and a component that is to be prevented from rotating in the locking direction. This is particularly if, in order to adjust a clearance of a brake while driving, the freewheel mechanism is switched on and is thus subjected to oscillations, vibrations, and impacts. In addition, when there are different thermal expansions, a cooling can lead to a sliding of the clamping elements of a frictionally engaging freewheel mechanism, which then release the freewheel mechanism.

Another advantage of the freewheel mechanism according to the invention is its compact design in the form of an electric motor, but with a limited pivoting angle of the armature. An additional advantage is the possibility of embodying it in a comparatively simple fashion from a structural standpoint, with the armature equipped with the locking element being the sole moving component. In this case, a rotating or pivoting support must be viewed as less susceptible to malfunction than a sliding guidance, for example of the bar of the known freewheel mechanism described above as the prior art.

Advantageous embodiments and modifications of the invention disclosed in claim 1 are the subject of the dependent claims.

According to claim 2, the armature equipped with the locking element is counterbalanced. During driving, accelerations acting on the freewheel mechanism, which can amount to approximately 60-80 g (60 to 80 times gravitational acceleration) for example when driving over a curb, do not exert any moment on the armature. This avoids an inadvertent switching on or switching off of the freewheel mechanism.

The subject of the other independent claim 8 is an electromechanical brake that is equipped with the freewheel mechanism according to the invention and is thus modified into an auxiliary brake. Its explanation is based on the above-mentioned explanations of the prior art and on the freewheel mechanism according to the invention.

In particular, the locking element of the freewheel mechanism engages with a gear of the electromagnetic actuating unit of the brake (claim 9). As a result, the freewheel mechanism functions with a gear that is already present. The gear can be part of a transmission of the electromechanical actuating unit of the brake. In particular, a pinion of a motor shaft of an electric motor of the electromechanical actuating unit of the brake is used as a gear for the freewheel mechanism. The moments are at their lowest in the motor shaft so that weak forces and moments act on the freewheel mechanism. In addition, the rotation is at its greatest in the motor shaft, thus enabling a finely graduated locking of the brake.

According to the method recited in claim 10, the freewheel mechanism according to the invention is switched on when the brake is released. This adjusts a clearance, i.e. a gap between a friction brake lining and a brake element; the freewheel mechanism locks in relation to a further releasing of the brake. This enables a clearance adjustment and therefore a readjustment with the occurrence of wear. For example, the freewheel mechanism is switched on when the friction brake lining lifts away from the brake element or when it has traveled a certain distance after lifting away from it. Preferably, the freewheel mechanism is only supplied with current in order to switch it on and is without current in the switched-on position. Return springs of the brake, which lift the friction brake lining away from the brake element when the brake is not being actuated, produce a prestressing force that keeps the freewheel mechanism engaged with the gear of the actuating device of the brake and therefore keeps it switched on.

### BRIEF DESCRIPTION OF THE DRAWINGS

The invention will be explained in greater detail below in conjunction with an exemplary embodiment shown in the drawings.

FIG. 1 shows an end view of a freewheel mechanism according to the invention; and

FIG. 2 is a schematic depiction of a brake according to the invention, equipped with the freewheel mechanism from FIG. 1.

### EMBODIMENT OF THE INVENTION

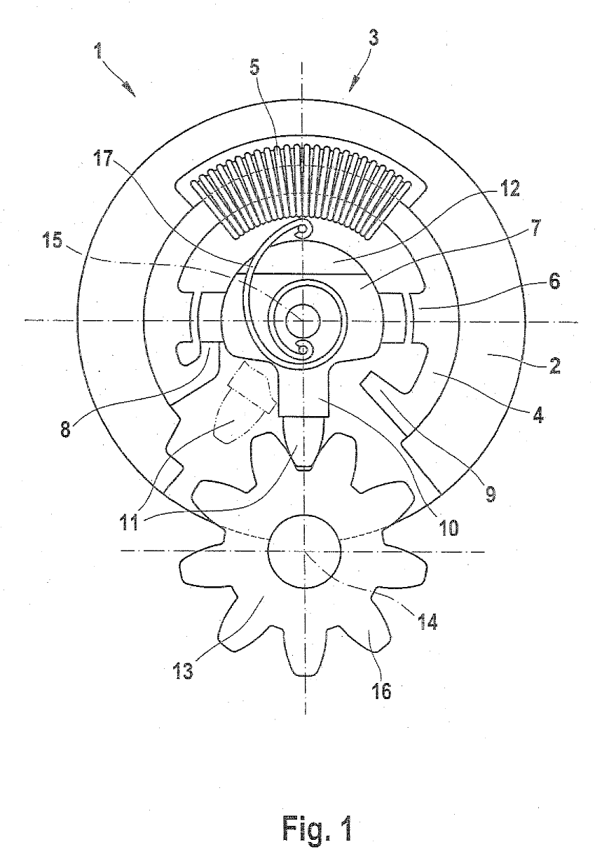

The freewheel mechanism 1 according to the invention shown in FIG. 1 is electromechanically switchable and functions in a form-locking fashion. Its design is comparable to that of an electric motor. The freewheel mechanism 1 has a hollow, cylindrical housing 2 equipped with an electromagnet 3. The electromagnet 3 has a likewise hollow, cylindrical yoke 4, also referred to as a stator, on which a coil 5 is situated. The yoke 4 is inserted, for example press-fitted, into the housing 2. The yoke 4 has two pole shoes 6 that protrude radially inward and are situated opposite from each other.

An armature 7 is pivotably supported coaxially in the housing 2 and its rotation angle is limited by two stops 8, 9. The stops 8, 9 protrude inward from the yoke 4. A locking element 10 with a tooth 11 protrudes radially from the armature 7. The locking element 10 is integrally joined to the armature 7. The armature 7 has a counterweight 12 opposite from the locking element 10; the armature 7 is counterbalanced.

The locking element 10 cooperates with a gear 13 whose imaginary axis 14 extends parallel to an imaginary axis 15 of the armature 7. The axis 14 of the gear 13 is situated outside the housing 2 of the freewheel mechanism 1. The housing 2 and the yoke 4 each have a recess on a section of their circumference through which part of the circumference of the gear 13 extends.

The locking element 10 cooperates with the gear 13. Through a supply of current to the coil 5 of the electromagnet 3, a moment is exerted on the armature 7, causing the armature 7 to pivot into the position shown in FIG. 1 in which the armature 7 rests against one of the two stops 8 that limits its pivot angle. In this position, the tooth 11 of the locking element 10 is engaged with teeth of 16 of the gear 13. Since the pivot angle of the armature 7 is limited by the stop 8, the tooth 11 of the locking element 10 prevents the gear 13 from rotating in one direction, i.e. the locking direction. In the opposite direction, i.e. the freewheeling direction, the teeth 16 of the gear 13 push the tooth 11 of the locking element 10 out of engagement; the gear 13 is able to rotate in the freewheeling direction. As long as the electromagnet 3 is supplied with current, a moment acts on the armature 7 that pushes its locking element 10 into engagement with the teeth 16 of the gear 13. The freewheel mechanism 1 is switched on.

A return spring element 17 that engages the armature 7 subjects the armature 7 to a moment oriented in the opposite direction from the moment of the electromagnet 3. When the electromagnet 3 is switched off, the return spring element 17 pivots the armature 7 against the other stop 9 and thus pivots the tooth 11 of the locking element 10 out of engagement with the teeth 16 of the gear 13. This position of the locking element 10 and its tooth 11 is depicted with dash/double-dot lines in FIG. 1. The freewheel mechanism 1 is switched off and the gear 13 is able to rotate in both rotation directions. The return spring element 17 is a spiral spring in the depicted embodiment of the invention.

In the embodiment of the invention described above and shown in the drawings, the freewheel mechanism 1 is monostable; when the electromagnet 3 is switched off, the return spring element 17 moves the freewheel mechanism 1 into the switched-off position. If the tooth 11 of the locking element 10 is engaged with the teeth 16 of the gear 13, the teeth 16 of the gear 13 hold the tooth 11 of the locking element 10 engaged in opposition to the moment of the return spring element 17 even when the electromagnet 3 is switched off; the gear 13 continues to be prevented from rotating in the locking direction. The freewheel mechanism 1 is only switched off by a short pivoting of the gear 13 in the freewheeling direction, which causes the tooth 11 of the locking element 10 to disengage from the teeth 16 of the gear 13.

In principle, a monostable embodiment of the freewheel mechanism 1 is also possible with the switched-off position as a stable position (not shown). A bistable embodiment of the freewheel mechanism 1 is also possible, for example by providing the one stop 8 and/or the armature 7 with a permanent magnet that holds the armature in contact with the respective stop 8, 9 in both end positions (not shown). A bistable embodiment of the freewheel mechanism 1 is also possible with a dead center spring element. After passage through the dead center, the dead center spring element acts on the armature 7 in the direction toward the one stop 8, 9 and after passage through the dead center in the opposite direction, it acts on the armature 7 in the direction toward the other stop 9, 8 (not shown). With a bistable embodiment of the freewheel mechanism 1, the electromagnet 3 is only supplied with current for switching back and forth; the supply of current is reversed for switching on and switching off. If the electromagnet cooperates with a permanent magnet (not shown), the switching on and off of the freewheel mechanism can occur through reversal of the polarity of the current supply to the electromagnet.

The tooth 11 of the locking element 10 is embodied like the tooth of a gear. The gear 13 has teeth 16 with symmetrical tooth flanks and is a conventional gear 13. It is not necessary for the gear 13 of the freewheel mechanism 1 to be provided with special gearing for example it does not have to be provided with sawtooth-shaped gearing. The tooth 11 of the locking element 10 and the teeth 16 of the gear 13 have rolling tooth flank forms, in particular in the shape of involutes or cycloids.

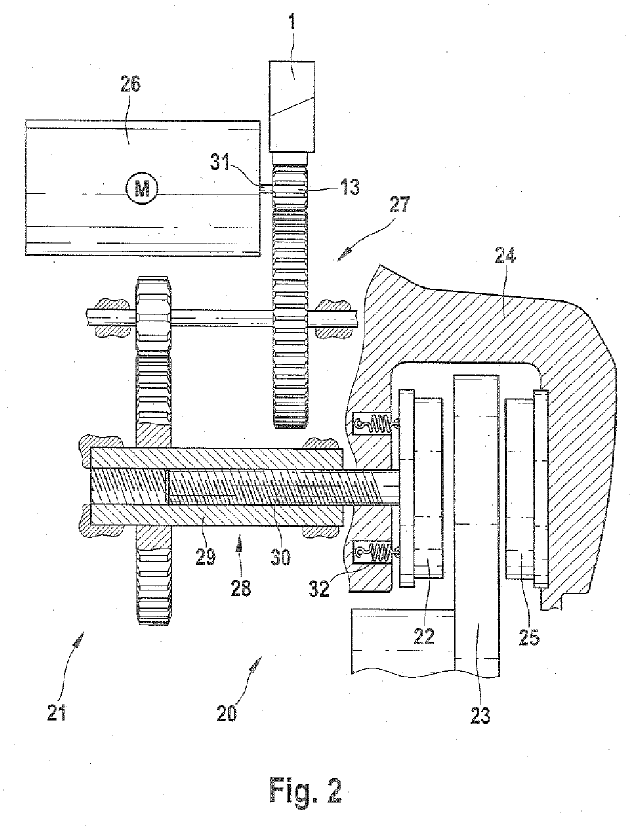

The electromechanical brake 20 according to the invention shown in schematic fashion in FIG. 2 has an electromagnetic actuating unit 21 that is able to press a friction brake lining 22 against a brake disc 23 in order to actuate a brake. The actuating unit 21 is situated in or on a brake caliper 24. The brake caliper 24 is embodied in the form of a floating caliper and is able to slide transversely in relation to the brake disc 23. If the friction brake lining 22 is pressed against the brake disc 23 in order to actuate the brake, then the brake caliper 24 shifts transversely in relation to the brake disc 23 and presses a second friction brake lining 25 situated on the opposite side against the other side of the brake disc 23, thus braking the latter.

The actuating device 21 has an electric motor 26 that drives a screw drive mechanism 28 via a mechanical reduction gear 27. The screw drive mechanism 28 has a nut 29 that is driven in rotary fashion by the reduction gear 27 and slides a spindle 30. The spindle 30 presses the friction brake lining 22 against the brake disc 23. The screw drive mechanism 28 constitutes a rotation/translation conversion gear. The reduction gear 27 in the exemplary embodiment shown is a two-stage gear mechanism.

The friction brake lining 22 is engaged by return springs 32, which are fastened to the brake caliper 24 and lift the friction brake lining away from the brake disc 23 when the brake 20 is not being actuated. In addition, the return springs prestress the actuating device 21, which is therefore without play.

A motor shaft 31 of the electric motor 26 is provided with a pinion that constitutes the gear 13 of the freewheel mechanism 1 shown in FIG. 1, which gear is depicted symbolically in FIG. 2. The pinion 13 of the electric motor 26 drives the reduction gear 27 of the actuating device 21.

The freewheel mechanism 1 acts on the pinion 13 of the electric motor 26. The freewheeling direction of the freewheel mechanism 1 corresponds to an application direction of the brake 20; the locking direction of the freewheel mechanism 1 therefore corresponds to a release direction of the brake 20. In the switched-on state, the freewheel mechanism 1 prevents the brake 20 from releasing; when the freewheel mechanism 1 is switched on, it is possible to apply the brake 20. When the freewheel mechanism 1 is switched off, the pinion 13 of the electric motor 26 is able to rotate in both rotation directions, i.e. it is possible to apply and release the brake 20.

In order to set the brake 20, it is actuated, i.e. applied, and the freewheel mechanism 1 is switched on once the brake 20 has been applied or as the brake is being applied. The switched-on freewheel mechanism 1 prevents the brake 20 from releasing; the exerted braking force is maintained even when the electric motor 26 is without current. As explained above in connection with FIG. 1, the tooth 11 of the locking element 10 of the freewheel mechanism 1 remains engaged with the teeth 16 of the gear or pinion 13 even when the electromagnet 3 is switched off. The set brake 20 therefore remains applied even when the electromagnet 5 of the freewheel mechanism 1 is switched off.

In order to switch off the freewheel mechanism 1 when the electromagnet 3 of the freewheel mechanism 1 is without current, the pinion 13 of the electric motor 26 must be moved a short distance in the applying direction of the brake 20, i.e. in the freewheeling direction of the freewheel mechanism 1, through a supply of current to the electric motor 26.

The teeth 16 of the pinion/gear 13 push the tooth 11 of the locking element 10 of the freewheel mechanism 1 out of engagement, thus switching off the freewheel mechanism 1. After the freewheel mechanism 1 is switched off, it is possible to release the brake 20.

The freewheel mechanism 1 engages the pinion 13 of the electric motor 26 because that is where the torque is at its lowest. In addition, the rotation of the pinion 11 is at its greatest during actuation and release of the brake 20, thus permitting the brake 20 to be adjusted in a finely graduated fashion through the engagement of the freewheel mechanism 1 with the pinion 13 of the electric motor 26. The compact, axially short design of the freewheel mechanism 1 permits it to be accommodated in the brake 20 in a space-saving fashion with regard to the pinion 13.

A clearance, i.e. a gap between the friction brake linings 22, 25 and the brake disc 23, is adjusted according to the invention by switching on the freewheel mechanism 1 upon release of the brake 20. The freewheel mechanism 1 is switched on when a desired clearance has been achieved as the brake 20 is being released. After a predeterminable rotation angle of the pinion 13 lifting of the friction brake linings 22, 25 have lifted away from the brake disc 23, the freewheel mechanism 1 can be switched on in order to adjust the desired clearance. The rotation angle of the pinion 13 can also be more than one full rotation. The clearance adjustment according to the invention makes it possible to compensate for a wear on the friction brake linings 22, 25 and brake disc 23; the clearance is always kept constant, independent of the wear state of the friction brake linings 22, 25.

The return springs 32, which lift the friction brake lining 22 away from the brake disc 23 and prestress the actuating unit 21, act on the switched-on freewheel mechanism 1 in the direction toward the switched-on position, acting via the screw drive mechanism 28 and the reduction gear 27 of the actuating unit 21. The freewheel mechanism 1 is thus held in the switched-on position in opposition to the force of its return spring element 17 and prevents the brake 20 from moving further in the release direction.

The form-locking embodiment of the freewheel mechanism 1 according to the invention reliably prevents an inadvertent release of the switched-on freewheel mechanism 1 even if the freewheel mechanism 1 is subjected to impacts and vibrations during driving. The fact that the armature 7 of the freewheel mechanism 1 is counterbalanced prevents accelerations of the freewheel mechanism 1 from exerting a moment on the armature 7 that might move the locking element 10 out of engagement with the gear/pinion 13. Impact-like accelerations for example the kind that occur when driving over a curb, can subject the freewheel mechanism 1 to up to approx. 60-80 g, i.e. 60 to 80 times gravitational acceleration.

1-10. (canceled)

11. An electromechanically switchable form-locking freewheel mechanism comprising:
an electromagnet for switching the freewheel mechanism;
a locking element that the electromagnet is able to bring into engagement with a gear in order to switch on the freewheel mechanism, the locking element preventing the gear from rotating in a locking direction while permitting the gear to rotate in a freewheeling direction opposite from the locking direction; and
an armature that is embodied in a fashion comparable to a rotor of an electric motor, whose pivoting angle is limited, and which is equipped with the locking element, wherein the electromagnet has a yoke that is embodied in the fashion of a stator of an electric motor and which encompasses the armature, and when supplied with current, the electromagnet exerts a moment on the armature which brings the locking element into or out of engagement with the gear.

12. The electromechanically switchable, form-locking freewheel mechanism as recited in claim 11, wherein the armature equipped with the locking element is counterbalanced.

13. The electromechanically switchable, form-locking freewheel mechanism as recited in claim 11, wherein the freewheel mechanism is monostable and has a spring element that moves the locking element out of engagement or into engagement with the gear.

14. The electromechanically switchable, form-locking freewheel mechanism as recited in claim 13, wherein the freewheel mechanism is switched on in opposition to a force of the spring element through a supply of current to the electromagnet.

15. The electromechanically switchable, form-locking freewheel mechanism as recited in claim 11, wherein the locking element has a tooth embodied in the form of a tooth of a gear.

16. The electromechanically switchable, form-locking freewheel mechanism as recited in claim 15, wherein the tooth of the locking element and the teeth of the gear have rolling tooth flank forms.

17. The electromechanically switchable, form-locking freewheel mechanism as recited in claim 11, wherein the gear has symmetrical tooth flanks.

18. An electromechanical brake for a motor vehicle, comprising
an electromechanical actuating unit;
a friction brake lining that the electromechanical actuating unit, in order to actuate the brake, is able to press against a brake element to be braked;
an electromechanical, switchable, form-locking freewheel mechanism having an electromagnet for switching the freewheel mechanism, having a locking element that the electromagnet is able to bring into engagement with a gear of the electromechanical actuating unit of the brake in order to switch on the freewheel mechanism, the locking element preventing the gear from rotating in a locking direction while permitting the gear to rotate in a freewheeling direction opposite from the locking direction, with the locking direction corresponding to a release direction of the brake and a freewheeling direction corresponding to an application direction of the brake, and having an armature that is embodied in a fashion comparable to a rotor of an electric motor, whose pivoting angle is limited, and which is equipped with the locking element; wherein the electromagnet has a yoke that is embodied in the fashion of a stator of an electric motor and encompasses the armature; and when supplied with current, the electromagnet exerts a moment on the armature, which brings the locking element into or out of engagement with the gear.

19. An electromechanical brake as recited in claim 18, wherein the gear with which the locking element of the freewheel mechanism can be brought into engagement is a gear of the electromechanical actuating unit of the brake.

20. A method for adjusting the clearance of an electromechanical brake comprising the steps of:
pressing a friction brake lining against a brake element to be braked, by means of an electromechanical actuating unit in order to actuate the brake;
preventing the electromechanical actuating unit of the brake from releasing the brake, by means of an electromechanically switchable form-locking freewheel mechanism in a switched-on state; and
switching on the freewheel mechanism once a desired clearance is achieved as the brake is being released.
